(19) United States
(12) Patent Application Publication
(10) Pub. No.: US 2024/0297765 A1
(43) Pub. Date: Sep. 5, 2024

(54) SYSTEMS, APPARATUS AND METHODS FOR PORT MUTING USING EXPLICIT CHANNEL FEEDBACK

(71) Applicant: Samsung Electronics Co., Ltd., Suwon-si (KR)

(72) Inventors: Karthik MURALIDHAR, Bangalore (IN); Diwakar SHARMA, Bangalore (IN); Dattaraj Dileep RAUT MULGAONKAR, Marcel (IN); Santanu MONDAL, Bangalore (IN); Youngbum KIM, Suwon-si (KR); Junyung YI, Suwon-si (KR)

(21) Appl. No.: 18/591,558

(22) Filed: Feb. 29, 2024

(30) Foreign Application Priority Data
Mar. 1, 2023 (IN) 202341013889
Feb. 15, 2024 (IN) 2023 41013889

(51) Int. Cl. H04L 5/00

(52) U.S. Cl. CPC H04L 5/0053

(57) ABSTRACT

The method includes transmitting, at least one user equipment (UE) node, configuration to feedback one or more downlink channel state information (CSI) feedback reports corresponding to one or more Channel state information-Reference signal (CSI-reference signal (RS) port muting patterns to the transceiver node, information regarding the one or more CSI-RS port muting patterns being included in the configuration, receiving, from the at least one UE node, one or more downlink CSI feedback reports, the one or more downlink CSI feedback reports comprising at least one of one or more individual CSI feedback reports corresponding to the one or more CSI-RS port muting patterns, a single multi-CSI feedback report corresponding to the one or more CSI-RS port muting patterns, and one or more CSI feedback reports comprising one or more quantized versions of at least a singular vector decomposition (SVD) decomposed downlink channel matrix corresponding to the one or more CSI-RS port muting patterns, and determining to mute at least one CSI-RS port belonging to at least one of the one or more port muting patterns or to unmute the at least one CSI-RS port belonging to the transceiver node, based on the one or more downlink CSI feedback reports.

### CROSS-REFERENCE TO RELATED APPLICATION(S)

This application is based on and claims priority under 35 U.S.C. § 119(a) of an Indian Provisional patent application number 202341013889, filed on Mar. 1, 2023, in the Indian Patent Office, and of an Indian Complete patent application number 202341013889, filed on Feb. 15, 2024, in the Indian Patent Office, the disclosure of each of which is incorporated by reference herein in its entirety.

### BACKGROUND

### 1. Field

The disclosure relates to wireless communication networks. More particularly, the disclosure relates to methods and systems for facilitating muting and unmuting of one or more antenna ports based on channel feedback in wireless communication networks.

### 2. Description of Related Art

Considering the development of wireless communication from generation to generation, the technologies have been developed mainly for services targeting humans, such as voice calls, multimedia services, and data services. Following the commercialization of 5G (5th-generation) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6G (6th-generation) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bps and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz band (for example, 95 GHz to 3THz bands). It is expected that, due to severer path loss and atmospheric absorption in the terahertz bands than those in mmWave bands introduced in 5G, technologies capable of securing the signal transmission distance (that is, coverage) will become more crucial. It is necessary to develop, as major technologies for securing the coverage, radio frequency (RF) elements, antennas, novel waveforms having a better coverage than orthogonal frequency division multiplexing (OFDM), beamforming and massive multiple input multiple output (MIMO), full dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the spectral efficiency and the overall network performances, the following technologies have been developed for 6G communication systems: a full-duplex technology for enabling an uplink transmission and a downlink transmission to simultaneously use the same frequency resource at the same time; a network technology for utilizing satellites, high-altitude platform stations (HAPS), and the like in an integrated manner; an improved network structure for supporting mobile base stations and the like and enabling network operation optimization and automation and the like; a dynamic spectrum sharing technology via collison avoidance based on a prediction of spectrum usage; an use of artificial intelligence (AI) in wireless communication for improvement of overall network operation by utilizing AI from a designing phase for developing 6G and internalizing end-to-end AI support functions; and a next-generation distributed computing technology for overcoming the limit of UE computing ability through reachable super-high-performance communication and computing resources (such as mobile edge computing (MEC), clouds, and the like) over the network. In addition, through designing new protocols to be used in 6G communication systems, developing mecahnisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services such as truly immersive extended reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide methods and systems for managing one or more antenna ports at the transceiver node within a wireless communication network, using one or more channel state information (CSI) feedback from at least one User Equipment (UE).

According to an embodiment of the disclosure, user equipment (UE) node comprising memory storing one or more computer programs and one or more processors coupled with the memory is provided.

The one or more computer programs may include computer-executable instruction that, when executed by the one or more processors, cause UE node to: receive, from the transceiver node, configuration to feedback one or more downlink channel state information (CSI) feedback reports corresponding to one or more Channel state information-Reference signal (CSI-reference signal (RS) port muting patterns to the transceiver node, wherein information regarding the one or more CSI-RS port muting patterns is included in the configuration.

The one or more computer programs may include computer-executable instruction that, when executed by the one or more processors, cause UE node to: measure one or more downlink channel state information (CSI).

The one or more computer programs may include computer-executable instructions that, when executed by the one or more processors, cause UE node to: transmit one or more CSI feedback reports to a transceiver node, wherein the one or more CSI feedback reports comprise at least one of, one or more individual CSI feedback reports corresponding to the one or more channel state information-reference signal (CSI-RS) port muting patterns, a single multi-CSI feedback report corresponding to the one or more CSI-RS port muting patterns, and one or more CSI feedback reports having quantized version of at least an SVD decomposed downlink channel matrix for the one or more CSI-RS port muting patterns.

According to an embodiment of the disclosure, a method performed by a user equipment (UE) node is provided. The method may comprise receiving, from the transceiver node, configuration to feedback one or more downlink channel state information (CSI) feedback reports corresponding to one or more Channel state information-Reference signal (CSI-reference signal (RS) port muting patterns to the transceiver node, wherein information regarding the one or more CSI-RS port muting patterns is included in the configuration. The method may comprise measuring one or more downlink channel state information (CSI). The method may comprise transmitting one or more CSI feedback reports to a transceiver node, wherein the one or more CSI feedback reports comprise at least one of, one or more individual CSI feedback reports corresponding to the one or more channel state information-reference signal (CSI-RS) port muting patterns, a single multi-CSI feedback report corresponding to the one or more CSI-RS port muting patterns, and one or more CSI feedback reports having quantized version of at least an SVD decomposed downlink channel matrix for the one or more CSI-RS port muting patterns.

According to an embodiment of the disclosure, a transceiver node comprising memory storing one or more computer programs and one or more processors communicatively coupled with the memory is provided. The one or more computer programs may include computer-executable instructions that, when executed by the one or more processors, cause the at least one transceiver node to: transmit, at least one user equipment (UE) node, configuration to feedback one or more downlink channel state information (CSI) feedback reports corresponding to one or more Channel state information-Reference signal (CSI-reference signal (RS) port muting patterns to the at least one transceiver node, wherein information regarding the one or more CSI-RS port muting patterns is included in the configuration.

The one or more computer programs may include computer-executable instructions that, when executed by the one or more processors, cause the at least one transceiver node to: receive, from the at least one UE node, one or more downlink CSI feedback reports, wherein the one or more downlink CSI feedback reports comprise at least one of one or more individual CSI feedback reports corresponding to the one or more CSI-RS port muting patterns, a single multi-CSI feedback report corresponding to the one or more CSI-RS port muting patterns, and one or more CSI feedback reports comprising one or more quantized versions of at least a singular vector decomposition (SVD) decomposed downlink channel matrix corresponding to the one or more CSI-RS port muting patterns. The one or more computer programs may include computer-executable instructions that, when executed by the one or more processors, cause the at least one transceiver node to: determine to mute at least one CSI-RS port belonging to at least one of the one or more port muting patterns or to unmute the at least one CSI-RS port, based on the one or more downlink CSI feedback reports.

According to an embodiment of the disclosure, a method performed by a transceiver node in a wireless communication system is provided. The method may comprise transmitting, at least one user equipment (UE) node, configuration to feedback one or more downlink channel state information (CSI) feedback reports corresponding to one or more Channel state information-Reference signal (CSI-reference signal (RS) port muting patterns to the transceiver node, wherein information regarding the one or more CSI-RS port muting patterns is included in the configuration.

The method may comprise receiving, from the at least one UE node, one or more downlink CSI feedback reports, wherein the one or more downlink CSI feedback reports comprise at least one of one or more individual CSI feedback reports corresponding to the one or more CSI-RS port muting patterns, a single multi-CSI feedback report corresponding to the one or more CSI-RS port muting patterns, and one or more CSI feedback reports comprising one or more quantized versions of at least a singular vector decomposition (SVD) decomposed downlink channel matrix corresponding to the one or more CSI-RS port muting patterns.

The method may comprise determining to mute at least one CSI-RS port belonging to at least one of the one or more port muting patterns or to unmute the at least one CSI-RS port belonging to the transceiver node, based on the one or more downlink CSI feedback reports.

Accordingly, the embodiments herein provide systems and methods for port muting using channel feedback for saving network energy.

Other aspects, advantages, and salient features of the disclosure will become apparent to those skilled in the art from the following detailed description, which, taken in conjunction with the annexed drawings discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 depicts a block diagram illustrating a system (1000) of network nodes of a wireless network for facilitating muting of one or more CSI-RS ports belonging to the one or more muting patterns using one or more CSI-RS channel feedbacks, according to an embodiment of the disclosure;

FIG. 2 depicts a method (2000) for facilitating muting of one or more CSI-RS ports belonging to the one or more pre-configured muting patterns, according to an embodiment of the disclosure;

FIG. 3 depicts, a method (3000) for facilitating unmuting of one or more CSI-RS ports, potentially belonging to the one or more muting patterns, according to an embodiment of the disclosure;

FIG. 4 depicts a method for facilitating co-scheduling of one or more UE nodes, in RRC connected mode with at least one transceiver node arranged within at least one Radio Access Network (RAN), according to an embodiment of the disclosure;

FIG. 5 is a flowchart depicting a process of transmission of a plurality of CSI feedback reports by the at least one UE, wherein the plurality of CSI feedback reports is generated corresponding to a plurality of CSI measured for a plurality of CSI-RS layers, according to an embodiment of the disclosure;

FIG. 6 is a flowchart, depicting a process for transmitting by at least one UE node (104) at least one multi-CSI feedback report corresponding to at least one of the configured muting patterns, according to an embodiment of the disclosure; and

FIGS. 7 and 8 depict a CSI acquisition process by the at least one transceiver node (102) using type II CSI feedback, according to various embodiments of the disclosure.

The same reference numerals are used to represent the same elements throughout the drawings.

### DETAILED DESCRIPTION

The following description with reference to the—accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It is to be understood that the terminology used herein is for the purposes of describing particular embodiments only and is not intended to be limiting. The terms “comprising”, “having” and “including” are to be construed as open-ended terms unless otherwise noted.

The words/phrases “exemplary”, “example”, “illustration”, “in an instance”, “and the like”, “and so on”, “etc.”, “etcetera”, “e.g.,”, “i.e.,” are merely used herein to mean “serving as an example, instance, or illustration.” Any embodiment or implementation of the disclosure described herein using the words/phrases “exemplary”, “example”, “illustration”, “in an instance”, “and the like”, “and so on”, “etc.”, “etcetera”, “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding of aspects of the embodiments as disclosed herein. Furthermore, in terms of the construction of the device, one or more components of the device may have been represented in the drawings by conventional symbols, and the drawings may show only those specific details that are pertinent to understanding the various embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the various embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

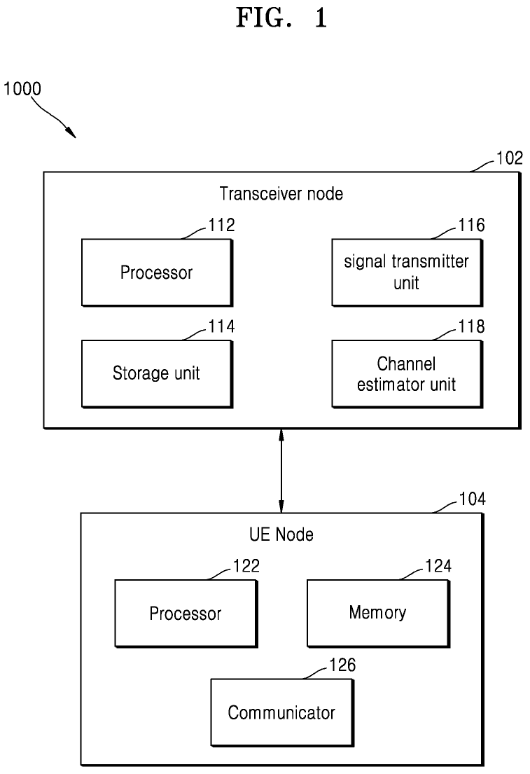

The embodiments herein achieve methods and systems for enabling muting and unmuting of one or more antenna ports using corresponding one or more CSI-RS channel feedbacks. Referring now to the drawings, and more particularly to FIGS. 1 to 8, where similar reference characters denote corresponding features consistently throughout the figures, there are shown at least one embodiment.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an integrated circuit (IC), or the like.

In general, Network energy saving (NES) work-item (WI) considers spatial- and power-domain techniques for Rel-18. As per agreed WID: RP-223540, RAN-1 may specify the following techniques in spatial and power domains:
Specify necessary enhancements on channel state information (CSI) and beam management related procedures including measurement and report, and signaling to enable efficient adaptation of spatial elements (for example, antenna ports, active transceiver chains) [RAN1, RAN2]; and
Specify necessary enhancements on CSI related procedures including measurement and report, and signaling to enable efficient adaptation of power offset values between physical downlink shared channel (PDSCH) and channel state information-reference signal (CSI-RS) [RAN1, RAN2].

Network power savings can be achieved by turning off TxRU(s) at the next generation node B (gNB). However, that can adversely impact the cell capacity if performed semi-statically. Therefore, performing the muting operations more dynamically is desirable. Further, unmuting of ports from a muting state is another important issue of concern, during dynamic real-time operations. Muting and/or unmuting operations will impact the downlink CSI measurements in the network. The gNB might require:
Multiple CSI feedbacks, potentially for multiple muting patterns; and
More detailed or informative CSI feedback (some more information in addition to current CSI feedback).

Hence, there is a need in the art for solutions which will overcome the above mentioned drawback(s), among others.

Another aspect of the disclosure is to provide methods and systems for muting and/or unmuting one or more antenna ports using the one or more CSI feedbacks corresponding to one or more port muting patterns as configured by the transceiver node.

Another aspect of the disclosure is to provide methods and systems for one or more antenna port muting using one or more CSI feedbacks, wherein a transceiver node is configured to capture one or more CSI feedback upon requesting at least one User Equipment (UE) transmission of the one or more CSI feedback information corresponding to one or more muting patterns of the one or more antenna ports present at the transceiver node.

Another aspect of the disclosure is to provide methods and systems for muting and unmuting one or more antenna ports using the one or more CSI feedbacks in order to control network energy consumption, wherein a quantized version of a singular vector decomposition (SVD) decomposed downlink channel matrix for the one or more CSI-RS port muting patterns is used for one or more CSI acquisition and the one or more CSI feedback report generation.

Another aspect of the disclosure is to provide methods and systems for muting and unmuting one or more antenna ports using the one or more CSI feedbacks corresponding to one or more muting patterns for network energy saving, wherein the one or more CSI feedbacks are received from a plurality of UEs, and the transceiver node can determine co-scheduling of more than one UEs selected from the plurality of UEs.

Another aspect of the disclosure is to provide methods and systems for transmitting by at least one UE node to at least one transceiver node one or more feedback reports corresponding to the one or more CSI-RS port muting patterns, wherein the one or more downlink CSI feedback reports can comprise at least one of, one or more individual CSI feedback reports corresponding to the one or more CSI-RS port muting patterns, a single multi-CSI feedback report corresponding to the one or more CSI-RS port muting patterns, and one or more CSI feedback reports having quantized version of an SVD decomposed downlink channel matrix for the one or more CSI-RS port muting patterns.

Additional aspects will be set forth in part in the description which follows and, in part, will be apparent from the description, or may be learned by practice of the presented embodiments.

In accordance with an aspect of the disclosure, a method for managing one or more channel state information-reference signal (CSI-RS) port muting patterns is provided. The method includes configuring by at least one transceiver node, at least one user equipment (UE) node to feedback to the at least one transceiver node, one or more downlink channel state information (CSI) feedback reports corresponding to the one or more CSI-RS port muting patterns, wherein the one or more downlink CSI feedback reports comprise at least one of one or more individual CSI feedback reports corresponding to the one or more CSI-RS port muting patterns, a single multi-CSI feedback report corresponding to the one or more CSI-RS port muting patterns, and one or more CSI feedback reports comprising one or more quantized versions of at least a singular vector decomposition (SVD) decomposed downlink channel matrix corresponding to the one or more CSI-RS port muting patterns, measuring by the at least one UE node, the one or more downlink CSI for the one or more CSI-RS port muting patterns, wherein the one or more CSI-RS port muting patterns are configured by the at least one transceiver node, and determining, by the at least one transceiver node, to mute at least one CSI-RS port belonging to at least one of the one or more port muting patterns or to unmute at least one CSI-RS port belonging to the at least one transceiver node, based on the one or more downlink CSI feedback reports.

In accordance with another aspect of the disclosure, at least one UE node is provided. The at least one UE node includes memory storing one or more computer programs, and one or more processors coupled with the memory, wherein the one or more computer programs include computer-executable instructions that, when executed by the one or more processors, cause the at least one UE node to measure one or more downlink channel state information (CSI), and transmit one or more CSI feedback reports to a transceiver network node, wherein the one or more CSI feedback reports comprise at least one of, one or more individual CSI feedback reports corresponding to the one or more channel state information-reference signal (CSI-RS) port muting patterns, a single multi-CSI feedback report corresponding to the one or more CSI-RS port muting patterns, and one or more CSI feedback reports having quantized version of at least an SVD decomposed downlink channel matrix for the one or more CSI-RS port muting patterns.

In accordance with another aspect of the disclosure, at least one transceiver node is provided. The at least one transceiver node includes memory storing one or more computer programs, and one or more processors communicatively coupled with the memory, wherein the one or more computer programs include computer-executable instructions that, when executed by the one or more processors, cause the at least one transceiver node to enable at least one UE node to feed back, to the at least one transceiver node, one or more downlink channel state information (CSI) feedback reports corresponding to one or more CSI-RS port muting patterns, wherein the one or more downlink CSI feedback reports comprise at least one of, one or more individual CSI feedback reports corresponding to the one or more CSI-RS port muting patterns, a single multi-CSI feedback report corresponding to the one or more CSI-RS port muting patterns, and one or more CSI feedback reports having quantized version of at least an SVD decomposed downlink channel matrix for the one or more CSI-RS port muting patterns, and determine to mute at least one CSI-RS port belonging to the one or more CSI-RS port muting patterns or to unmute at least one CSI-RS port belonging to the at least one transceiver node, based on the one or more downlink CSI feedback reports.

In accordance with another aspect of the disclosure, a system is provided. The system includes at least one UE node and at least one transceiver node, wherein the system is configured to obtain one or more downlink channel state information (CSI) feedback reports corresponding to the one or more CSI-RS port muting patterns, wherein the one or more downlink CSI feedback reports comprise at least one of, one or more individual CSI feedback reports corresponding to the one or more CSI-RS port muting patterns, a single multi-CSI feedback report corresponding to the one or more CSI-RS port muting patterns, and one or more CSI feedback report having quantized version of a singular vector decomposition (SVD) decomposed downlink channel matrix for the one or more CSI-RS port muting patterns, and determine to mute at least one CSI-RS port belonging to the one or more CSI-RS port muting patterns or to unmute at least one CSI-RS port belonging to the at least one transceiver node, based on the one or more downlink CSI feedback reports.

In accordance with another aspect of the disclosure, one or more non-transitory computer-readable storage media storing one or more computer programs including computer-executable instructions that, when executed by one or more processors of at least one user equipment (UE) node, cause the at least one UE node to perform operations are provided. The operations include configuring by at least one transceiver node, at least one user equipment (UE) node to feedback to the at least one transceiver node, one or more downlink channel state information (CSI) feedback reports corresponding to the one or more CSI-RS port muting patterns, wherein the one or more downlink CSI feedback reports comprise at least one of one or more individual CSI feedback reports corresponding to the one or more CSI-RS port muting patterns, a single multi-CSI feedback report corresponding to the one or more CSI-RS port muting patterns, and one or more CSI feedback reports comprising one or more quantized versions of at least a singular vector decomposition (SVD) decomposed downlink channel matrix corresponding to the one or more CSI-RS port muting patterns, measuring, by the at least one UE node, the one or more downlink CSI for the one or more CSI-RS port muting patterns, wherein the one or more CSI-RS port muting patterns are configured by the at least one transceiver node, and determining, by the at least one transceiver node, to mute at least one CSI-RS port belonging to at least one of the one or more port muting patterns or to unmute at least one CSI-RS port belonging to the at least one transceiver node, based on the one or more downlink CSI feedback reports.

FIG. 1 depicts a block diagram illustrating a system (1000) of network nodes of a wireless network for facilitating muting of one or more CSI-RS ports of one or more muting patterns using one or more CSI-RS channel feedbacks according to an embodiment of the disclosure.

Referring to FIG. 1, the system (1000) comprises at least one transceiver node (102), and at least one user equipment (UE) node (102). The wireless network can be, for example, but not limited to, a fourth generation (4G) network, a fifth generation (5G) network, a 6G network, an Open Radio Access Network (ORAN) or the like. The at least one UE node (104) can be, for example, but not limited to a laptop, a smart phone, a desktop computer, a notebook, a Device-to-Device (D2D) device, a vehicle to everything (V2X) device, a foldable phone, a smart TV, a tablet, an immersive device, an internet of things (IOT) device, or any other device capable of using the wireless network. The transceiver node can be, for example, but not limited to a base station, a gNB, an eNB, a new radio (NR) trans-receiver or the like.

The at least one transceiver node (102) comprises a processor (112), a storage unit (114), a signal transmitter unit (116), and a channel estimator unit (118). The processor (112) of the at least one transceiver node can facilitate configuration of one or more muting patterns with one or more CSI-RS ports of the at least one transceiver node. Further, the processor (112) can configure the at least one UE (104) in RRC connected mode, to receive one or more CSI-RS signals corresponding to one or more configured muting patterns of the at least one transceiver node. The one or more CSI-RS signals are transmitted from the signal transmitter unit (116), wherein the signal transmitter unit (116) comprises one or more configured muting patterns. Further, the processor (112) can configure the at least one UE (104) to measure one or more CSIs corresponding to the one or more configured muting patterns. The one or more CSIs can be, without limitation, one or more Channel Quality Indicators (CQIs) to measure signal-to-noise ratio in the one or more CSI-RS channels to estimate quality of them, one or more Rank Indicators (RI) to determine one or more CSI-RS channels can transmit downlink data pertaining to favorable channel conditions of the at least one UE node, one or more Precoding Matrix Indicators (PMIs) for estimating one or more optimized CSI-RS channels to be used by the at least one UE node for optimal reception of downlink data, and so on. In an embodiment herein, the one or more configured muting patterns of the at least one transceiver node (102) can be at least one of, one or more fully unmuted CSI-RS port patterns, and one or more partially unmuted CSI-RS port patterns.

The processor (112) of the at least one transceiver node (102) further can receive one or more CSI feedback reports from the at least one UE node (104), wherein the one or more CSI feedback reports comprises one or more measured Channel Quality Indicators (CQIs), one or more measured Rank Indicators (RI), and one or more estimated Precoding Matrix Indicators (PMIs). In an embodiment herein, the processor (112) further can receive one or more energy-feedback reports on estimated fraction of energy as captured by the at least one UE node (104) for the one or more configured muting patterns and estimates amount of residual energy present in the UE's downlink channel which was not fed back.

The channel estimator unit (118) of the at least one transceiver node (102) can generate one or more precoding information by performing estimated precoding for one or more new downlink channel matrices, based on the one or more measured CSI feedback reports as received from the at least one UE node (104), for optimizing transmission of new downlink data through the use of one or more new CSI-RS channel estimates corresponding to one or more new port muting patterns, in order to facilitate network energy saving. Further, the channel estimator engine (118) can transmit the one or more precoding information to the processor (114) for optimizing the one or more downlink channels by way of enabling selection of one or more new muting patterns by muting and unmuting one or more CSI-RS ports from the configured muting patterns. In an example embodiment herein, the one or more estimated downlink channel matrices for downlink precoder determination, and for subsequent use during downlink data transmission, are precoded from one or more right singular vectors of the one or more measured PMIs as feedback with the one or more CSI feedback reports, one or more left singular vectors of the one or more measured PMIs as feedback with the one or more CSI feedback reports, and one or more singular values of the one or more downlink channel matrices corresponding to the one or more configured CSI-RS port muting patterns.

The processor (112) can facilitate muting and unmuting of one or more CSI-RS ports based on the one or more measured CSI feedback reports, the one or more energy-feedback reports as received form the at least one UE node (104), and the one or more precoding information as obtained from the channel estimator unit (118), thereby enabling generation of one or more new port muting patterns.

The storage unit (114) is configured to store a history of a plurality of port muting patterns with a corresponding plurality of CSI-RS feedback reports and a plurality of energy-feedback reports. In an embodiment herein, the plurality of port muting patterns as pre-stored in the storage unit are compared with one or more configured muting patterns of the transceiver node, based on the CSI-RS feedback and energy-feedback, in order to determine whether to unmute one or more CSI-RS ports of the at least one transceiver node (102), potentially from the one or more configured port muting patterns.

The processor (112) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (112) may include multiple cores and is configured to execute the instructions stored in the storage unit (114).

Further, the processor (112) is configured to execute instructions stored in the storage unit (114) and to perform various processes. The storage unit (114) also stores instructions to be executed by the processor (112). The storage unit (114) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the storage unit (114) may, in some examples, be considered a non-transitory storage medium. The term “non-transitory” may indicate that the storage medium is not embodied in a carrier wave or a propagated signal. However, the term “non-transitory” should not be interpreted that the storage unit (114) is non-movable. In certain examples, a non-transitory storage medium may store data that can, over time, change (e.g., in Random Access Memory (RAM) or cache).

The at least one UE node (104) can comprise a processor (122), memory (124), and a communicator (126). The processor (122) of the at least one UE node (104) can be configured by the at least one transceiver node (102) to receive the one or more transmitted CSI-RS signals according to the one or more configured muting patterns, and measure the one or more CSI-RS signals corresponding to the one or more configured muting patterns. Further, the processor (122) can be configured by the at least one transceiver node (102) to feedback one or more CSI feedback reports in order to enable the processor (112) of the transceiver unit to determine one or more CSI-RS port muting and unmuting based on one or more CSI measurements. The one or more CSIs corresponding to the one or more configured muting patterns comprise one or more PMIs, one or more CQIs, and one or more RIs. Further, the processor (122) of the at least one UE node (104) can be configured to measure the one or more PMIs using a type II CSI codebook procedure of estimating downlink channel matrix corresponding to the one or more configured muting patterns by singular vector decomposition (SVD) of the downlink channel matrix and using a quantized version of SVD decomposed downlink channel matrix corresponding to the one or more configured muting patterns. In an embodiment herein, the one or more PMIs of the one or more CSI feedback reports are measured by the at least one UE node (104) using singular vector decomposition of one or more downlink channel matrices (corresponding to the configured one or more muting patterns), and obtaining one or more precoder matrices from one or more right singular vectors and the one or more left singular vectors of one or more downlink channel matrices. The one or more downlink channel matrices can be one or more H_{N}_{_{RX}}_{X P} matrices, wherein N_{RX} is the total number of ports at the receiver side and P is the total number of CSI-RS ports used for CSI-RS transmission.

The processor (122) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (122) may include multiple cores and is configured to execute the instructions stored in the memory (124).

Further, the processor (122) is configured to execute instructions stored in the memory (124) and to perform various processes. The communicator (126) is configured for communicating internally between internal hardware components and with external devices via one or more networks. The memory (124) also stores instructions to be executed by the processor (122). The memory (124) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (230) may, in some examples, be considered a non-transitory storage medium. The term “non-transitory” may indicate that the storage medium is not embodied in a carrier wave or a propagated signal. However, the term “non-transitory” should not be interpreted that the memory (124) is non-movable. In certain examples, a non-transitory storage medium may store data that can, over time, change (e.g., in Random Access Memory (RAM) or cache).

In an embodiment herein, the communicator (126) can include an electronic circuit specific to a standard that enables wired or wireless communication. The communicator (126) is configured to communicate internally between internal hardware components of the at least one UE node (104) and with external devices via one or more networks.

Although the FIG. 1 shows various hardware components of the at least one UE node (104), but it is to be understood that other embodiments are not limited thereon. In other embodiments, the at least one UE node (104) may include less or more number of components. Further, the labels or names of the components are used only for illustrative purpose and does not limit the scope of the disclosure. One or more components can be combined together to perform same or substantially similar function in the at least one UE node (104).

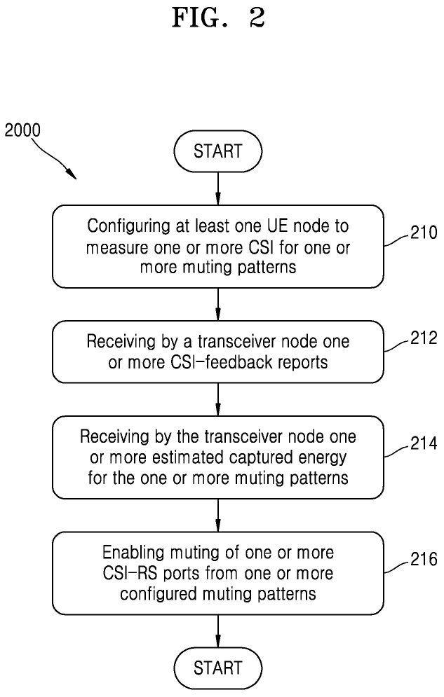

FIG. 2 depicts a method (2000) for facilitating muting of one or more CSI-RS ports of one or more configured muting patterns, according to an embodiment of the disclosure.

Referring to FIG. 2, at operation 210, the method comprises configuring by at least one transceiver node (102) (such as a gNB in 5G NR), at least one user Equipment (UE) node (104), to measure one or more downlink channel state information (CSI) corresponding to one or more configured muting patterns with the one or more CSI-RS ports. For example, the at least one transceiver node (102) can transmit configuration regarding downlink channel state information reference signals (CSI-RSs) corresponding to the one or more muting patterns, to the at least one UE node (104). In an embodiment herein, the one or more configured muting patterns are defined as one or more muting patterns of CSI-RS ports as configured by the processor (112) of the at least one transceiver node (102), and for which the at least one UE measures the one or more CSIs. The at least one transceiver node (102) can transmit one or more downlink channel state information reference signals (CSI-RSs) corresponding to the one or more muting patterns, to the at least one UE node (104). In an embodiment herein, the at least one UE node (104) can measure one or more CSIs corresponding to the one or more CSI-RSs for enabling optimizing by the at least one transceiver node (102) the energy-consumption during CSI-RS or downlink data transmission. The one or more CSIs comprise, one or more measured Channel Quality Indicators (CQI), one or more measured Rank Indicators (RI), and one or more measured Precoding Matrix Indicators (PMI). With respect to an embodiment herein, the one or more muting patterns can be at least one of, one or more fully unmuted CSI-RS port patterns, and one or more partially unmuted CSI-RS port patterns. In an example embodiment herein, the at least one transceiver node (102) can configure the at least one UE node (104) to measure the one or more CSIs for the one or more configured muting patterns, and to report one or more individual CSI-feedback reports for the one or more configured muting patterns. Further, in an embodiment herein, the at least one transceiver node (102) can configure the at least one UE node (104) to measure the one or more CSIs for the one or more configured muting patterns, and feedback a multi-CSI feedback report for the one or more configured muting patterns, wherein the multi-CSI feedback report comprises measured CSIs for each configured muting pattern of the one or more configured muting patterns. Further, the at least one transceiver node (102) can configure the at least one UE node (104) to measure the one or more CSIs for the one or more configured muting patterns, and feedback one or more CSI feedback reports having quantized version of at least an SVD decomposed downlink channel matrix corresponding to the one or more configured muting patterns.

At operation 212, the method comprises receiving by the at least one transceiver node (102) one or more CSI feedback reports corresponding to the one or more configured muting patterns. The one or more CSI feedback reports comprise one or more measured Channel Quality Indicators (CQI), one or more measured Rank Indicators (RI), and one or more measured Precoding Matrix Indicators (PMI). The one or more CSI feedback reports can be transmitted by the at least one UE node (104) to optimize downlink transmissions on at least one of a Physical downlink shared channel (PDSCH), and a Physical downlink control channel (PDCCH). In an example embodiment herein, the one or more CSI feedback reports can be transmitted using at least one of a physical uplink shared channel (PUSCH), and a physical uplink control channel (PUCCH). Further, in an example embodiment herein, the at least one UE node (104) can transmit at least one muti-CSI report comprising a plurality of measured CSIs for at least one subset of muting patterns, wherein the at least one subset of muting patterns is selected from one or more muting patterns as configured by the at least one transceiver node (102).

At operation 214, the method comprises receiving by the at least one transceiver node (102), one or more energy-feedback reports on one or more estimated fractions of energy as captured by the UE for one or more configured port muting patterns. The at least one UE node (104) can estimate the one or more fractions of energy as captured in the downlink CSI-RS channel estimate for the one or more configured port muting patterns. Further, the UE can estimate the one or more fractions of energy as captured for each muting pattern of the subset of configured muting patterns and transmit as an aggregated energy-feedback report for the subset of configured muting patterns, wherein the aggregated energy-feedback report comprising an aggregated value of the one or more fractions of energy as captured for each muting pattern of the subset of the configured muting patterns. In an example embodiment herein, the at least one UE node (104) can estimate the fraction of energy as captured by the subset of configured muting patterns from one or more singular values of a downlink channel matrix corresponding to the subset of the muting pattern and a total number of CSI-RS layers. Further, in an embodiment herein, the aggregated energy-feedback report on estimated captured energy by the subset of configured muting patterns can be obtained from at least one of the following estimation mechanisms:

$$\frac{{\sum }_{i = 1}^{v} \vert {σ}_{i} \vert}{Trace ( abs ( \sum ) )}$$

(where the abs(Σ) is calculated element-by-element of a downlink channel matrix); and

$$\frac{{\sum }_{i = 1}^{v} {\vert {σ}_{i} \vert}^{2}}{Trace ( \sum {\sum }^{*} )} ,$$

where, Σ is a diagonal matrix containing one or more singular values of the downlink channel matrix H_{N}_{_{RX}}_{X P} in descending order of magnitude, σᵢ denotes the i-th singular value of the H and v-layer CSI feedback is considered. Here N_{RX} ports at the receiver side and P ports at the transmitter side are assumed to be present for considered CSI-RS transmission. The aforestated forms of fractions of captured energy is used by the at least one transceiver node (102) to estimate residual energy in the at least one UE's downlink channel that was not fed back, which in turn, is used by the transceiver node to decide whether to mute or unmute one or more ports based on the estimation of the residual energy.

At operation 216, the method comprises enabling by the transceiver node muting of one or more CSI-RS ports corresponding to the one or more configured muting patterns. In an embodiment herein, the at least one transceiver node (102) can select an appropriate muting pattern from the one or more configured muting patterns, and can mute one or more CSI-RS ports of one or more configured muting patterns other than the appropriate muting pattern as selected. Selection of the appropriate muting pattern is determined based on the one or more CSI-feedback reports of the one or more configured muting patterns. The appropriate muting pattern is the pattern that satisfies system throughput requirements for downlink transmission with optimal usage of network energy. Additionally, the selection of the appropriate muting pattern is determined based on the feedback on estimated captured energy by the one or more configured muting patterns. In an embodiment herein, selection of the appropriate muting pattern by muting one or more CSI-RS ports aids in enhanced downlink channel quality with network-energy saving property.

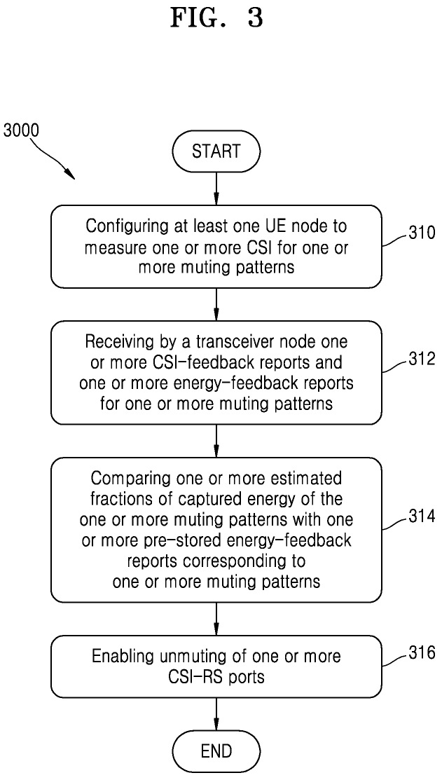

FIG. 3 depicts, a method (3000) for facilitating unmuting of one or more CSI-RS ports of one or more pre-configured muting patterns, according to an embodiment of the disclosure.

Referring to FIG. 3, at operation 310, the method comprises configuring by at least one transceiver node (102) (such as a gNB in 5G NR), at least one UE node (104), to measure one or more downlink channel state information (CSI) corresponding to one or more configured muting patterns of the one or more CSI-RS ports. For example, the at least one transceiver node (102) can transmit configuration regarding downlink channel state information reference signals (CSI-RSs) corresponding to the one or more muting patterns, to the at least one UE node (104).

At operation 312, the method further comprises receiving by the transceiver node one or more CSI-feedback reports generated based on measured CSI corresponding to the one or more configured muting patterns. Further, the method comprises receiving by the at least one transceiver node (102) one or more energy-feedback reports on estimated fraction of energy as captured by the one or more configured muting patterns. At operation 314, the method comprises, comparing by the at least one transceiver node (102), the one or more energy data as received corresponding to the one or more configured muting patterns with one or more pre-stored energy-feedback reports corresponding to one or more previously configured muting patterns.

At operation 316, the method comprises enabling by the at least one transceiver node (102), unmuting of one or more CSI-RS ports corresponding to the one or more configured muting patterns. The at least one transceiver node (102) can select an appropriate muting pattern from the one or more configured muting patterns. The appropriate muting pattern can be selected based on the one or more CSI-feedback reports of the one or more configured muting patterns, wherein the appropriate muting pattern satisfies system throughput requirements for downlink transmission with optimal usage of network energy. Additionally, the appropriate muting pattern can be selected based on the feedback on estimated captured energy by the one or more pre-configured muting patterns. The at least one transceiver node (102) can enable unmuting of one or more CSI-RS ports, upon estimating the minimal network energy being captured for the appropriate muting pattern as selected from the one or more configured muting patterns and presence of maximal residual energy in the UE's downlink channel which is not fed back. Further, unmuting one or more specific CSI-RS ports from one or more pre-configured muting patterns other than the selected appropriate muting pattern can be based on comparing an estimated energy (as captured by the selected appropriate muting pattern) with one or more pre-stored estimated energy (corresponding to one or more configured muting patterns, other than the selected appropriate muting pattern). In an embodiment herein, unmuting of the one or more specific CSI-RS ports can be performed, based on comparing a preferred CSI feedback report for the selected appropriate muting pattern with the one or more pre-stored CSI feedback reports of the one or more configured muting patterns other than the selected appropriate muting pattern. The selection of the appropriate muting pattern by unmuting one or more CSI-RS ports aids in enhanced downlink channel quality with network energy saving property.

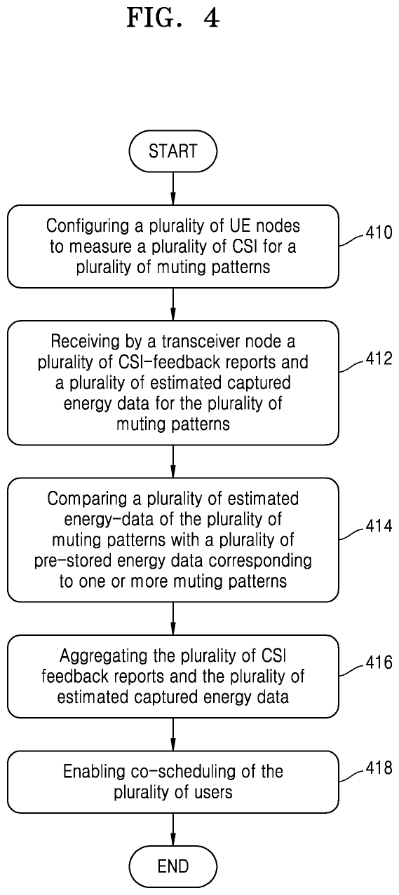

FIG. 4 depicts a method for facilitating co-scheduling of one or more UE nodes, in RRC connected mode with at least one transceiver node arranged within at least one Radio Access Network (RAN), according to an embodiment of the disclosure.

Referring to FIG. 4, at operation 410, the method comprises configuring by the at least one transceiver node (102) (such as a gNB in 5G NR), each UE node of the plurality of UE nodes, to measure a plurality of downlink channel state information (CSI) corresponding to a plurality of muting patterns of a plurality of CSI-RS ports. For example, the at least one transceiver node (102) can transmit configuration to measure a plurality of downlink channel state information (CSI) corresponding to a plurality of muting patterns of a plurality of CSI-RS ports, to the at least one UE node (104). In an embodiment herein, the plurality of muting patterns can comprise at least one of multiple sets of fully unmuted CSI-RS ports, and multiple sets of partially unmuted CSI-RS ports. The at least one transceiver node (102) can transmit a plurality of channel state information reference signals (CSI-RSs) corresponding to the plurality of muting patterns to the plurality of UE nodes. In an embodiment herein, each UE node of the plurality of UE nodes can measure the plurality of CSIs for the plurality of CSI-RSs. The plurality of CSIs comprise a plurality of Channel Quality Indicators (CQIs), a plurality of Rank Indicators (RI), and a plurality of Precoding Matrix Indicators (PMIs). The plurality of CSIs is measured for optimizing the plurality of downlink channel quality while maintaining optimal energy usage in the network.

At operation 412, the method comprises receiving by the at least one transceiver node (102) a plurality of CSI feedback reports from the plurality of UE nodes, corresponding to the plurality of muting patterns. In an embodiment herein, the plurality of CSI feedback reports comprise a plurality of measured Channel Quality Indicators (CQIs), a plurality of measured Rank Indicators (RI), and a plurality of measured Precoding Matrix Indicators (PMIs), for the plurality of muting patterns. The plurality of CSI feedback reports can be transmitted by each of the plurality of UE nodes in order to enable optimizing of downlink transmissions to the plurality of UE nodes through at least one of a plurality of Physical downlink shared channels (PDSCH), and a plurality of Physical downlink control channels (PDCCH), as configured for downlink transmissions. In an example embodiment herein, the plurality of CSI feedback reports (as received from each UE node of the plurality of UE nodes) can be reported using at least one of, a plurality of physical uplink shared channels (PUSCHs), and a plurality of physical uplink control channels (PUCCHs) within the at least one RAN. Further, in an embodiment, the plurality of CSI feedback reports (as received from each UE node of the plurality of UE nodes) can be reported as a multi-CSI feedback report corresponding to the plurality of configured muting patterns for the plurality of UE nodes, wherein the multi-CSI feedback report comprises measured CSIs for one or more port muting patterns for each UE node of the plurality of UE nodes. Further, in an embodiment, the plurality of CSI feedback reports (as received from each UE node of the plurality of UE nodes) can be reported as one or more CSI feedback reports having quantized version of a plurality of SVD decomposed downlink channel matrices corresponding to the plurality of configured muting patterns of the plurality of UE nodes.

At operation 414, the method comprises, comparing by the at least one transceiver node (102), the one or more energy data as received corresponding to the one or more configured muting patterns with one or more pre-stored energy-feedback reports corresponding to one or more previously configured muting patterns.

The method further comprises receiving a plurality of energy-feedback reports on fraction of energy captured by each UE of the plurality of UE nodes for the plurality of muting patterns by the at least one transceiver node (102). Each UE node of the plurality of UE nodes can estimate a plurality of fraction of energies as captured for the plurality of muting patterns. In an example embodiment herein, the plurality of UE nodes can estimate the plurality of fractions of energy as captured corresponding to the plurality of muting patterns from a plurality of singular values of a downlink channel matrix corresponding to the plurality of configured muting patterns and a plurality of CSI-RS layer counts. Further, in an embodiment herein, the plurality of energy feedback reports on an estimated fraction of energy as captured by each UE node of the plurality of UE nodes, corresponding to the plurality of muting patterns can be obtained from at least one of the following:

$$\frac{{\sum }_{i = 1}^{v} \vert {σ}_{i} \vert}{Trace ( abs ( \sum ) )}$$

(where the abs(Σ) is calculated element-by-element of a downlink channel matrix); and

$$\frac{{\sum }_{i = 1}^{v} {\vert {σ}_{i} \vert}^{2}}{Trace ( \sum {\sum }^{*} )} ,$$

where, Σ is a diagonal matrix containing a plurality singular values of the downlink channel matrix H_{N}_{_{RX}}_{X P} in descending order of magnitude, σᵢ denotes the i-th singular value of the H and v-layer CSI feedback is considered. Here N_{RX} ports at the receiver side and P ports at the transmitter side are assumed to be present for considered CSI-RS transmission. The aforestated forms of fractions of captured energy is used by the at least one transceiver node to estimate residual energy in one or more UE's downlink channel that was not fed back, which in turn, can be used by the at least one transceiver node to decide muting and unmuting of one or more CSI-RS ports based on the estimation of the residual energy.

At operation 416, the method comprises aggregating, by the at least one transceiver node (102), the plurality of CSI feedback reports, as received from each UE node, and the plurality of energy-feedback reports on estimated fraction of energies as captured by the plurality of UE nodes, in order to obtain a plurality of appropriate precoders for downlink transmissions. At operation 418, the method comprises facilitating, by the at least one transceiver node (102), co-scheduling of one or more UE nodes from the plurality of UE nodes upon obtaining a plurality of appropriate precoders for downlink transmissions to the one or more UE nodes as co-scheduled from the plurality of UE nodes.

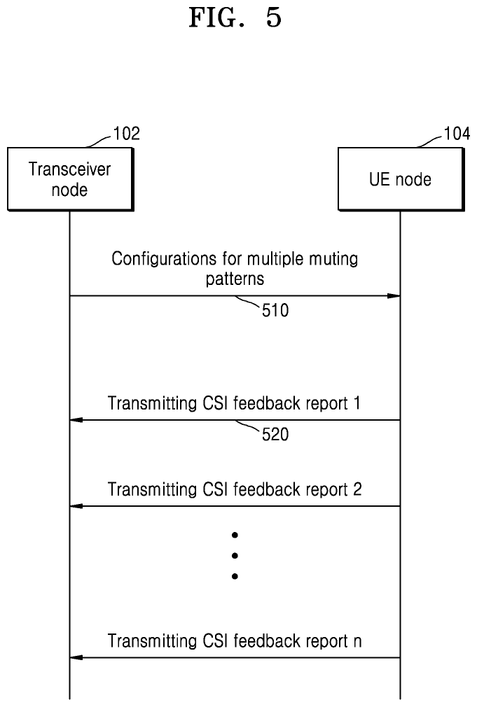

FIG. 5 is a flowchart depicting a process of transmission of a plurality of CSI feedback reports by the at least one UE node (104), wherein the plurality of CSI feedback reports are generated corresponding to a plurality of CSI measured for a plurality of CSI-RS layers according to an embodiment of the disclosure.

Referring to FIG. 5, at operation 510, the at least one transceiver node (102) (such as a gNB in 5G NR) configures one or more CSI-RS port muting patterns (herein after referred as configured muting patterns) corresponding to one or more downlink CSI-RS ports. For example, the at least one transceiver node (102) can transmit configuration regarding one or more CSI-RS port muting patterns corresponding to the one or more downlink CSI-RS ports, to the at least one UE node (104). In an embodiment herein, the one or more configured muting patterns can be one of one or more fully unmuted CSI-RS port patterns, or one or more partially unmuted CSI-RS port patterns. The at least one transceiver node (102) can configure the at least one UE node (104), to use one or more CSI reference signals corresponding to the one or more configured muting patterns, in order to at least measure individual channel state information (CSI) corresponding to the one or more configured muting patterns. Further, the at least one transceiver node (102) can configure the at least one UE node (104) to report individual CSI-feedback reports corresponding to the one or more configured muting patterns. Therefore, the at least one transceiver node (102) can capture the individual CSI feedback reports corresponding to the one or more configured muting patterns by way of requesting the at least one UE to feedback the individual CSI as measured corresponding to each muting pattern of the one or more configured muting patterns.

In operation 520, the at least one UE node (104) measures the individual CSI corresponding to each muting pattern of the one or more muting patterns, wherein the individual CSIs can comprise at least a measured CQI, a measured PMI, and a measured RI, for the one or more muting patterns. The at least one UE node (104) further, transmits one or more individual CSI feedback reports to the at least one transceiver node (102), wherein the individual CSI feedback reports correspond to the as measured individual CSI for each muting pattern. The at least one transceiver node (102) thus, collects the one or more individual CSI-feedback reports corresponding to the one or more configured muting patterns from the at least one UE node (104). In an embodiment herein, the at least one transceiver node (102) uses the one or more individual CSI-feedback reports for selecting at least one muting pattern from the one or more muting patterns, and can mute one or more unmuted CSI-RS ports of other muting patterns. Further, in an embodiment herein, the at least one transceiver node can collect the one or more individual CSI-feedback reports from a plurality of UEs configured by the at least one transceiver node (102) to measure CSI for the one or more configured muting patterns. The at least one transceiver node, can select one or more appropriate muting patterns and can enable co-scheduling of more than one UEs based on the one or more individual CSI-feedback reports as collected from the plurality of UEs, such that, network energy can be used in a conservative manner.

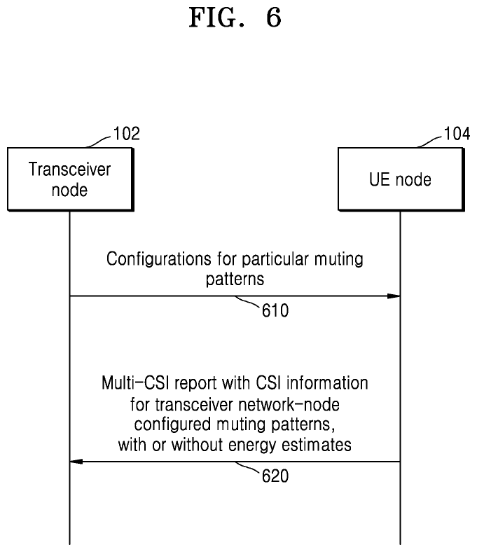

FIG. 6 is a flowchart, depicting a process for transmitting by at least one UE node (104) at least one multi-CSI feedback report corresponding to at least one of the configured muting patterns according to an embodiment of the disclosure.

Referring to FIG. 6, at operation 610, the at least one transceiver node (102) configures the at least one UE node (104), to measure a plurality of CSIs corresponding to each muting pattern of the at least one subset of configured muting pattern. For example, the at least one transceiver node (102) can transmit configuration to measure a plurality of CSIs corresponding to each muting pattern of the at least one subset of configured muting pattern, to the at least one UE node (104). Further, the at least one transceiver node (102) configures the at least one UE node (104) to feedback to the at least one transceiver node (102), at least one aggregated energy feedback report corresponding to the at least one subset of configured muting pattern. In an embodiment herein, the at least one subset of muting pattern comprises at least one of one or more fully unmuted CSI-RS port patterns, and one or more partially unmuted CSI-RS port patterns.

At operation 620, the at least one transceiver node (102) collects the at least one multi-CSI feedback report by way of requesting the at least one UE (104) to feedback at least one aggregated CSI information corresponding to the at least one subset of muting pattern (as configured by the at least one transceiver node (102)). Further, the at least one transceiver node (102) collects the at least one energy feedback report by way of requesting the at least one UE (104) to feedback at least one aggregated fraction of captured energy corresponding to the at least one subset of muting pattern. In an example embodiment herein, based on the one or more configured muting patterns, the at least one UE node (104) can be configured by an RRC signaling to derive the one or more CSIs for one or more derived muting patterns, from a lesser number of CSI-RS transmissions than the number of muting patterns (in particular, using a single CSI-RS transmission). Further, the at least one UE node (104) can select a subset of muting pattern(s) from the one or more derived muting patterns (potentially subject to a “restriction set” as indicated by the transceiver node (102)) according to one or more internal metrics of at least one UE nodes. The one or more internal metrics can be, but not limited to, rate, and so on. The at least one UE can send a multi-CSI report corresponding to the selected subset of muting pattern(s).

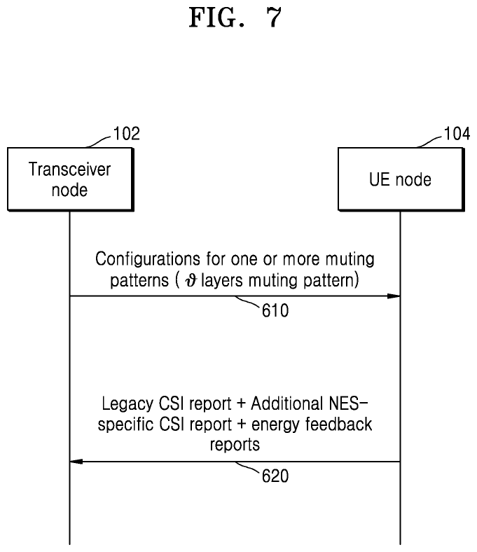

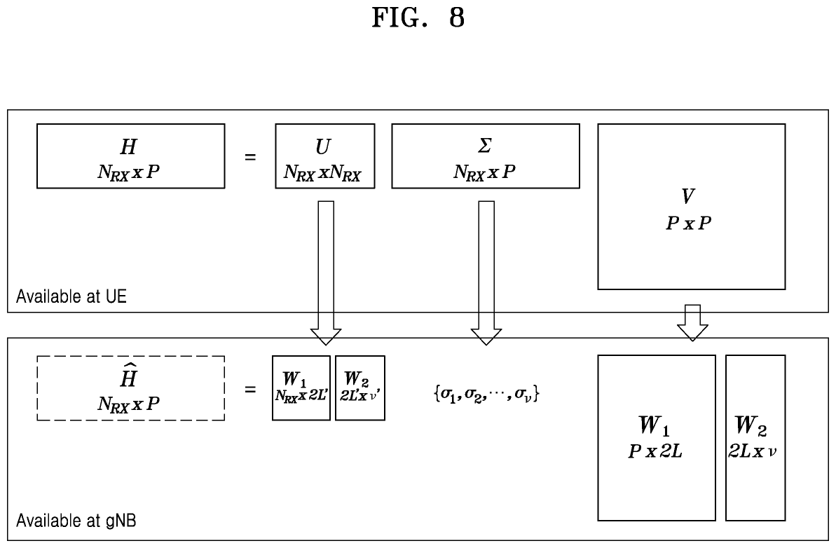

FIGS. 7 and 8 depict a CSI acquisition process by obtaining quantized version of at least one SVD decomposed downlink channel matrix for the one or more configured CSI-RS port muting patterns, using type II CSI feedback according to various embodiments of the disclosure.

Referring to FIGS. 7 and 8, at operation 710, the at least one transceiver node (102) configures the at least one UE node (104) to measure CSI for configured port muting patterns for v layers, wherein the configured port muting patterns for the v layers are at least one of v layers of fully unmuted CSI-RS port muting patterns and v layers of partially unmuted CSI-RS port muting patterns. For example, the at least one transceiver node (102) can transmit configuration to measure CSI for configured port muting patterns for at least one layer, to the at least one UE node (104). Further, the at least one transceiver node (102) configures the at least one UE node (104) to feedback a v layer-CSI-feedback report for the port muting patterns of configured v layers. For example, the at least one transceiver node (102) can transmit configuration to feedback a v layer-CSI-feedback report for the port muting patterns of configured v layers. At operation 2, the at least one UE node (104) measures v layers-CSI for the configured muting patterns of the v layers, and feedback a CQI, a PMI and an RI information corresponding to each muting pattern of the configured muting patterns for v layers. The PMI is obtained by performing singular vector decomposition (SVD) of at least one downlink channel matrix corresponding to the configured port muting patterns for v layers and by performing quantization of at least one SVD decomposed downlink channel matrix at the at least one UE node (104). The PMI comprises of a right precoder matrix ((W₁W₂)_{P×v}, wherein P is the total number of ports at the CSI-RS transmitter side) of v right singular vectors of the at least one SVD decomposed downlink channel matrix, a left precoder matrix (W₁W₂)_{N}_{_{RX}}_{×v}, wherein N_{RX} is the total number of CSI-RS receiving antenna ports at the receiver side) of v left singular vectors of the at least one SVD decomposed downlink channel matrix, and v singular values corresponding to the at least one SVD decomposed downlink channel matrix. In an embodiment herein, the PMI can be reported with lower periodicity or higher periodicity depending on at least one downlink channel property such as without limitation coherence time of downlink transmission.

In an embodiment herein, the at least one transceiver node (102) can receive at a current timestamp, the right precoder matrix of v right singular vectors of the at least one SVD decomposed downlink channel matrix and the v singular values corresponding to the at least one SVD decomposed downlink channel matrix, based on the at least one SVD decomposed downlink channel property. Therefore, in order to obtain, at least one new downlink channel matrix corresponding to at least one new port muting pattern, the at least one transceiver node (102), can use an old left precoder matrix of v left singular vectors of the at least one SVD decomposed downlink channel matrix, obtained at a previous timestamp.

Further, the at least one transceiver node (102) can receive at a current timestamp the left precoder matrix of v left singular vectors of the at least one SVD decomposed downlink channel matrix and the v singular values corresponding to the at least one SVD decomposed downlink channel matrix, based on the at least one SVD decomposed downlink channel property. Therefore, in order to obtain, at least one new downlink channel matrix corresponding to at least one new port muting pattern, the at least one transceiver node (102), can use an old right precoder matrix of v right singular vectors of the at least one SVD decomposed downlink channel matrix, obtained at a previous timestamp.

For v layers-CSI acquisition, the at least one UE node (102) can estimate at least one downlink channel matrix H_{N}_{_{RX}}_{X P} for the muting patterns of v layers and performs singular-value decomposition (SVD) on it (as depicted in FIG. 8):

$$H = U \sum {V}^{*} ,$$

where V* denotes the conjugate-transpose of matrix V and Σ is a diagonal matrix containing the singular values of H in descending order of magnitudes. Here, P ports at the transmit side and N_{RX} ports at the receive side are assumed to be used for v layers CSI acquisition. The at least one transceiver node (102) can send v-layer downlink data using the v right singular vectors for obtaining the PMI corresponding to each configured muting pattern of the configured muting patterns of v layers.

Type II PMI codebook assumes precoder structure (W) as W=W₁W₂, where

$${W}_{1} = [ \begin{matrix}B & 0 \\ 0 & B\end{matrix} ] ,$$

wherein B is composed of L oversampled 2D DFT beams with horizontal and vertical polarizations. Further, B can be obtained using a polynomial basis, a Slepian basis, and so on, used for beamforming, by considering M sub-bands of the downlink v layers. In an embodiment, the at least one left precoder matrix is obtained from at least one appropriate beamforming basis vector comprising at least one of at least one oversampled 2D-DFT (discrete Fourier transform) basis, at least one Slepian basis, and at least one polynomial basis. Further, in an embodiment herein, the at least one right precoder matrix is obtained from at least one appropriate beamforming basis vector comprising at least one of at least one oversampled 2D-DFT (discrete Fourier transform) basis, at least one Slepian basis, and at least one polynomial basis.

The matrix dimensions of W₁, W₂ corresponding to the right singular vectors of an SVD decomposed channel matrix H_{N}_{_{RX}}_{X P}, are as follows:
W₁: P X 2L
W₂: 2L X v
where we are considering for v layers CSI feedback for the right precoder matrix.

Further, the matrix dimensions of W₁, W₂ corresponding to the left singular vectors of SVD decomposed channel matrix H_{N}_{_{RX}}_{X P} are as follows:
W₁: N_{RX}x 2L′
W₂: 2L′xv′
where we are considering that for v′ layers could be used for CSI feedback for the left precoder matrix and the layer count v′ may differ from the v layer count above.

The at least one UE node (104) can feed back with the PMIs for v layers of configured muting patterns, W₁ and W₂ (corresponding to the right singular vectors of SVD decomposed channel matrix H_{N}_{_{RX}}_{X P}, and the left singular vectors of SVD decomposed channel matrix H_{N}_{_{RX}}_{X P}). The at least one transceiver node (102) can estimate a new channel matrix for new muting patterns from the as received W₁ and W₂ corresponding to the right singular vectors of SVD decomposed channel matrix H_{N}_{_{RX}}_{X P}, and the left singular vectors of SVD decomposed channel matrix H_{N}_{_{RX}}_{X P}. In an embodiment herein, the new channel matrix is generated by muting one or more CSI-RS ports from the configured muting patterns of v layers, thus aiding network energy saving. Further, in an embodiment, the new channel matrix is generated by unmuting one or more CSI-RS ports at the at least one transceiver node (102). Further, in an embodiment herein, the new channel matrix corresponds to new muting patterns can be generated depending on the energy-feedback reports corresponding to the configured muting patterns of v layers. The at least one UE node (104) can send an estimate of the fraction of energy captured for each configured muting pattern of the configured muting patterns of v layers to the at least one transceiver node (102). The estimated energy, can be obtained from:

$$\frac{{\sum }_{i = 1}^{v} \vert {σ}_{i} \vert}{Trace ( abs ( \sum ) )}$$

(where the abs(·) is taken element-by-element)

$$\frac{{\sum }_{i = 1}^{v} {\vert {σ}_{i} \vert}^{2}}{Trace ( \sum {\sum }^{*} )} ,$$

where σᵢ denotes the i-th singular value of downlink channel matrix H. The fractions of captured energy will help the at least on transceiver node (102) to estimate the residual energy in the UE's downlink channel that was not included in the feedback.

The at least one UE node (104) can feed back the right singular vectors (columns of V matrix) (legacy CSI feedback) and an additional CSI feedback comprising left singular vectors (columns of U matrix), and v singular values from the diagonal matrix Σ comprising singular values of the downlink channel H_{N}_{_{RX}}_{X P}. The additional feedback is expected to be much smaller in dimension since a typical deployment scenario has N_{RX}<<P. The feedback overhead is reduced due to sending a single CSI feedback report having quantized version of a SVD decomposed downlink channel matrix for the one or more CSI-RS port muting patterns.

The additional CSI feedback (columns of U matrix and v singular values from the diagonal matrix Σ) can either be sent along with existing feedback, which comprises only of the right singular vectors (columns of V matrix), as part of the same CSI report. Otherwise, the additional CSI feedback can be sent separately with lower periodicity, to cause more reduction in the overall feedback overhead.

The at least one transceiver node (102) collects a plurality of CSI information from a plurality of UE nodes and uses the plurality of CSI information for co-scheduling the plurality of UE nodes. Since the at least one transceiver node (102) has the v-rank approximation of each user's channel, it can decide on the one or more CSI-RS port(s) to mute to minimally impact network capacity or some other system metric of choice. Once the at least one transceiver node (102) can then jointly determine the users to be (co-)scheduled and the transmit ports to mute upon receiving the W precoders from the plurality of UE nodes. For example, at least one transceiver node (102) can:
suitably determine the CSI-RS ports to mute to incur minimal capacity loss; and
dynamically change the transmit ports to mute from slot-to-slot.

Embodiments herein disclose systems and methods for port muting using channel feedback for saving network energy. Embodiments herein disclose systems and methods for port muting using channel feedback for saving network energy, wherein at least one transceiver network node transmits a request to at least one UE to feedback one or more channel state information (CSI) information, in order to capture the one or more channel state information (CSI) for controlling energy consumption by one or more CSI-RS or antenna ports. The at least one UE can be configured to feedback the one or more individual CSI feedback report corresponding to one or more muting patterns configured by the at least one transceiver node. Further, the at least one UE, can feedback a multi-CSI feedback report for a subset of muting patterns, configured by the at least one transceiver node, wherein the muti-CSI feedback report comprises a set of collective CSI information for the subset of muting patterns as configured. Embodiments herein disclose methods and systems for one or more CSI-RS port muting and unmuting using CSI channel feedback thereby aiding effective use of network energy, wherein type II CSI feedback can be used for CSI acquisition by the at least one UE. Embodiments herein further disclose methods and systems for saving network energy by port muting using channel feedback, wherein the gNB requests the UE to feedback CSI information (for capturing CSI), including legacy (type II) and additional measurements, in order to decide the appropriate muting pattern.

The embodiment disclosed herein describes methods and systems for enabling port muting using CSI feedback. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in at least one embodiment through or together with a software program written in e.g., Very high speed integrated circuit Hardware Description Language (VHDL) another programming language, or implemented by one or more VHDL or several software modules being executed on at least one hardware device. The hardware device can be any kind of portable device that can be programmed. The device may also include means which could be e.g., hardware means like e.g., an application-specific integrated circuit (ASIC), or a combination of hardware and software means, e.g., an ASIC and a field programmable gate array (FPGA), or at least one microprocessor and at least one memory with software modules located therein. The method embodiments described herein could be implemented partly in hardware and partly in software. Alternatively, the disclosure may be implemented on different hardware devices, e.g., using a plurality of CPUs. The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method of any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a transceiver node in a wireless communication system, the method comprising:
transmitting, at least one user equipment (UE) node, configuration to feedback one or more downlink channel state information (CSI) feedback reports corresponding to one or more Channel state information-Reference signal (CSI-reference signal (RS) port muting patterns to the transceiver node, wherein information regarding the one or more CSI-RS port muting patterns is included in the configuration;
receiving, from the at least one UE node, one or more downlink CSI feedback reports, wherein the one or more downlink CSI feedback reports comprise at least one of one or more individual CSI feedback reports corresponding to the one or more CSI- RS port muting patterns, a single multi-CSI feedback report corresponding to the one or more CSI-RS port muting patterns, and one or more CSI feedback reports comprising one or more quantized versions of at least a singular vector decomposition (SVD) decomposed downlink channel matrix corresponding to the one or more CSI-RS port muting patterns; and
determining to mute at least one CSI-RS port belonging to at least one of the one or more port muting patterns or to unmute at least one CSI-RS port belonging to the transceiver node, based on the one or more downlink CSI feedback reports.

2. The method of claim 1, wherein the receiving of the one or more downlink CSI feedback reports comprises:
receiving, from the at least one UE node, at least one CSI feedback report having quantized version of an SVD decomposed downlink channel matrix for the one or more CSI-RS port muting patterns, wherein the at least one CSI feedback report comprises at least one precoding matrix indicator (PMI) parameter, and wherein the at least one PMI parameter comprises at least one of: one or more right singular vectors, one or more left singular vectors, and one or more singular values corresponding to the SVD decomposed downlink channel matrix for the one or more CSI-RS port muting patterns, and wherein the determining to mute at least one CSI-RS port belonging to at least one of the one or more port muting patterns or to unmute the at least one CSI-RS port comprises:
determining, by the at least one transceiver node, to mute the at least one CSI-RS port belonging to the one or more CSI-RS port muting patterns or to unmute the at least one CSI-RS port belonging to the at least one transceiver node, based on the received at least one CSI feedback report.

3. The method of claim 1, further comprising:
transmitting, to the at least one UE node, one or more downlink CSI-RS, wherein the downlink CSI feedback reports are obtained based on the one or more downlink CSI for the one or more CSI-RS port muting patterns.

4. The method of claim 1, wherein the one or more CSI-RS port muting patterns are at least one of:
one or more fully unmuted CSI-RS port muting patterns; and
one or more partially unmuted CSI-RS port muting patterns.

5. The method of claim 1, further comprising:
receiving, from the at least one UE node, one or more energy feedback reports comprising the one or more fractions of energy as captured for the one or more CSI-RS port muting patterns, wherein the determining to mute at least one CSI-RS port belonging to at least one of the one or more port muting patterns or to unmute the at least one CSI-RS port comprises:
determining to mute the at least one CSI-RS port belonging to the one or more CSI-RS port muting patterns or to unmute the at least one CSI-RS port belonging to the at least one transceiver node, based on the one or more energy feedback reports.

6. The method of claim 1, further comprising:
receiving, from the at least one UE node, one or more energy-feedback reports on estimated fraction of energy captured by the downlink channel matrix for the one or more CSI-RS muting patterns; and
performing comparison analysis of the one or more energy-feedback report with a history of one or more pre-stored energy-feedback reports corresponding to the one or more CSI-RS port muting patterns, wherein the determining to mute at least one CSI-RS port belonging to at least one of the one or more port muting patterns or to unmute the at least one CSI-RS port comprises determining to unmute, at least one CSI-RS port belonging to the at least one transceiver node, based on the one or more CSI feedback reports and output of the comparison analysis.

7. The method of claim 1, further comprising:
transmitting, to the at least one UE node, configuration to measure the one or more downlink CSI for the one or more CSI-RS port muting patterns.

8. The method of claim 2, wherein the one or more right singular vectors and the one or more left singular vectors comprise at least one of:
one or more wideband and long-term downlink channel properties; and
one or more sub-band and short-term downlink channel properties.

9. The method of claim 1, wherein the determining to mute at least one CSI- RS port belonging to at least one of the one or more port muting patterns or to unmute the at least one CSI-RS port comprises determining whether to mute the at least one CSI-RS port belonging to the one or more CSI-RS port muting patterns or to unmute the at least one CSI-RS port belonging to the transceiver node, by way of estimating residual energy, which has not been fed back, in the one or more downlink channels corresponding to the at least one CSI-RS port muting pattern of the UE node.

10. The method of claim 1, further comprising:
transmitting, to the at least one UE node, configuration to measure a plurality of CSI corresponding to a plurality of CSI-RS port muting patterns, as configured by the at least one transceiver node;
receiving, from the at least one UE node, a plurality of CSI feedback reports corresponding to the plurality of CSI-RS port muting patterns, wherein the plurality of CSI feedback reports comprising a plurality of corresponding PMIs;
receiving, from the at least one UE node, a plurality of energy-feedback reports on estimated fraction of energy captured for the plurality of CSI-RS port muting patterns;
performing comparison analysis, of the plurality of energy-feedback reports with a history of plurality of pre-stored energy-feedback reports corresponding to the plurality of CSI-RS port muting patterns; and
determining by the at least one transceiver node, to mute at least one CSI-RS port belonging to the one or more CSI-RS port muting patterns or to unmute at least one CSI-RS port belonging to the at least one transceiver node based on the plurality of CSI feedback reports, the plurality of energy-feedback reports and output of the comparison analysis.

11. The method of claim 10, wherein the fraction of captured energy for the one or more CSI-RS port muting patterns is estimated from a ratio of, one or more singular values of the downlink channel matrix corresponding to the one or more CSI- RS port muting patterns, to a diagonal matrix containing one or more singular values in descending order of magnitude of the downlink channel matrix.

12. The method of claim 1, further comprising:
determining at least one downlink channel matrix for one or more CSI-RS transmission corresponding to the one or more CSI-RS port muting patterns, wherein the at least one downlink channel matrix is obtained from at least one left precoder matrix having one or more left singular vectors, wherein the at least one left precoder matrix has total number of rows equal to total number of CSI-RS receiving antenna ports at a CSI-RS receiver side, and total number of columns equal to total number of CSI-RS layers configured by the at least one transceiver node, at least one right precoder matrix having one or more right singular vectors, wherein the at least one right precoder matrix has total number of rows equal to total number of CSI-RS transmit ports at a CSI-RS transmitter side, and total number of columns equal to total number of CSI-RS layers configured by the at least one transceiver node, and one or more singular values of an estimated downlink channel matrix as obtained from the at least one UE node, wherein the at least one left precoder matrix is obtained from at least one appropriate beamforming basis vector comprising at least one of at least one oversampled 2D discrete Fourier transform (2D-DFT) basis, at least one Slepian basis, and at least one polynomial basis, and wherein the at least one right precoder matrix is obtained from at least one appropriate beamforming basis vector comprising at least one of at least one oversampled 2D-DFT basis, at least one Slepian basis, and at least one polynomial basis.

13. The method of claim 1, wherein the one or more downlink CSI corresponding to the one or more CSI-RS port muting patterns comprise one or more channel quality indicator (CQIs), one or more precoder matrix indicators (PMIs) and one or more rank indicator (RIs).

14. A user equipment (UE) node comprising:
memory storing one or more computer programs; and
one or more processors coupled with the memory, wherein the one or more computer programs include computer-executable instructions that, when executed by the one or more processors, cause UE node to:
receive, from the transceiver node, configuration to feedback one or more downlink channel state information (CSI) feedback reports corresponding to one or more Channel state information-Reference signal (CSI-reference signal (RS) port muting patterns to the transceiver node, wherein information regarding the one or more CSI-RS port muting patterns is included in the configuration, measure one or more downlink channel state information (CSI), and transmit one or more CSI feedback reports to a transceiver node, wherein the one or more CSI feedback reports comprise at least one of, one or more individual CSI feedback reports corresponding to the one or more channel state information-reference signal (CSI-RS) port muting patterns, a single multi-CSI feedback report corresponding to the one or more CSI-RS port muting patterns, and one or more CSI feedback reports having quantized version of at least an SVD decomposed downlink channel matrix for the one or more CSI-RS port muting patterns.

15. The UE node of claim 14, wherein the one or more computer programs further include computer-executable instructions that, when executed by the one or more processors, cause the at least one UE node to:
estimate one or more fractions of captured energy for the one or more CSI-RS port muting patterns, wherein the fractions of captured energy is estimated from one or more singular values of the downlink channel matrix corresponding to the one or more CSI-RS port muting patterns; and
transmit, to the transceiver node, one or more energy-feedback reports comprising one or more fractions of estimated energy captured for the one or more CSI- RS port muting patterns.

16. A transceiver node comprising:
memory storing one or more computer programs; and
one or more processors communicatively coupled with the memory, wherein the one or more computer programs include computer-executable instructions that, when executed by the one or more processors, cause the at least one transceiver node to:
transmit, at least one user equipment (UE) node, configuration to feedback one or more downlink channel state information (CSI) feedback reports corresponding to one or more Channel state information-Reference signal (CSI- reference signal (RS) port muting patterns to the at least one transceiver node, wherein information regarding the one or more CSI-RS port muting patterns is included in the configuration, receive, from the at least one UE node, one or more downlink CSI feedback reports, wherein the one or more downlink CSI feedback reports comprise at least one of one or more individual CSI feedback reports corresponding to the one or more CSI-RS port muting patterns, a single multi- CSI feedback report corresponding to the one or more CSI-RS port muting patterns, and one or more CSI feedback reports comprising one or more quantized versions of at least a singular vector decomposition (SVD) decomposed downlink channel matrix corresponding to the one or more CSI-RS port muting patterns, and determine to mute at least one CSI-RS port belonging to at least one of the one or more port muting patterns or to unmute the at least one CSI-RS port, based on the one or more downlink CSI feedback reports.

17. The transceiver node of claim 16, wherein one or more computer programs further include computer-executable instructions that, when executed by the one or more processors, cause the at least one transceiver node to:
receive from the at least one UE node, one or more estimated fractions of energy captured for the one or more CSI-RS port muting patterns, wherein the fractions of captured energy is estimated from one or more singular values of the downlink channel matrix corresponding to the one or more CSI-RS port muting patterns; and
determine to mute the at least one CSI-RS port belonging to the one or more CSI- RS port muting patterns or to unmute the at least one CSI-RS port belonging to the at least one transceiver node, based on the received one or more estimated fractions of energy.

18. The transceiver node of claim 16, wherein the one or more CSI-RS port muting patterns are at least one of:
one or more fully unmuted CSI-RS port muting patterns; and
one or more partially unmuted CSI-RS port muting patterns.

19. The transceiver node of claim 17, wherein the fraction of captured energy for the one or more CSI-RS port muting patterns is estimated from a ratio of, one or more singular values of downlink channel matrix corresponding to the one or more CSI- RS port muting patterns, to a diagonal matrix containing one or more singular values in descending order of magnitude of the downlink channel matrix.

20. A method performed by a user equipment (UE) node comprising:
receiving, from the transceiver node, configuration to feedback one or more downlink channel state information (CSI) feedback reports corresponding to one or more Channel state information-Reference signal (CSI-reference signal (RS) port muting patterns to the transceiver node, wherein information regarding the one or more CSI-RS port muting patterns is included in the configuration;
measuring one or more downlink channel state information (CSI); and
transmitting one or more CSI feedback reports to a transceiver node, wherein the one or more CSI feedback reports comprise at least one of, one or more individual CSI feedback reports corresponding to the one or more channel state information-reference signal (CSI-RS) port muting patterns, a single multi-CSI feedback report corresponding to the one or more CSI-RS port muting patterns, and one or more CSI feedback reports having quantized version of at least an SVD decomposed downlink channel matrix for the one or more CSI-RS port muting patterns.
